(19) United States
(12) Patent Application Publication
(10) Pub. No.: US 2006/0226566 A1
(43) Pub. Date: Oct. 12, 2006

(54) Imprinting apparatus, system and method

(75) Inventors: Jeong Bok Kwak, Gyeonggi-do (KR); Il Sang Maeng, Gyeonggi-do (KR); Seung Hyun Ra, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/326,778

(22) Filed: Jan. 5, 2006

(30) Foreign Application Priority Data
Apr. 7, 2005 (KR) 10-2005-0029027

(51) Int. Cl. B29C 59/02

(52) U.S. Cl. 264/40.1; 264/293; 264/406; 264/408; 264/410; 425/385

(57) ABSTRACT

The present invention relates to an imprinting apparatus, system and method. Specifically, the present invention relates to an imprinting apparatus, system and method, which can be applied to a large substrate, in which a substrate is aligned, imprinted through sequential pressurization by the imprinting apparatus to form a circuit pattern on the substrate and easily released from the imprinting apparatus.

The present application claims priority under 35 U.S.C. §119 to Korean Patent Application No. 10-2005-0029027 filed on Apr. 7, 2005. The content of the application is incorporated herein by reference in its entirety.

### BACKGROUND OF THE INVENTION

1. Field of the Invention

The present invention relates, generally, to an imprinting apparatus, system and method. More particularly, the present invention relates to an imprinting apparatus, system and method, which can be applied to a large substrate, in which a substrate is aligned, imprinted through sequential pressurization by the imprinting apparatus to form a circuit pattern on the substrate and easily released from the imprinting apparatus.

2. Description of the Related Art

According to recent trend toward the fabrication of light, slim, short and small electronic products to be miniaturized, made thin, highly dense, packaged and personally portable, miniaturization and packaging of a printed circuit board (PCB) are also required. Thus, in order to increase the reliability and design density of the PCB, the layer structure of a circuit is complicated, with a change of material for PCBs. In addition, while electronic parts vary from a DIP (Dual In-line Package) type to an SMT (Surface Mount Technology) type, mounting densities thereof are increasing. In addition, designs for PCBs are becoming complicated, with the need for considerably difficult techniques, due to portability and high functionality of electronic devices, and necessity for sending/receiving large sized data, such as Internet data and moving images through the electronic devices.

For small and highly dense PCBs, fineness of a circuit pattern must be realized above all. That is, the demand for a highly dense substrate is increasing, and thus, requirements for line/space become further fined.

Generally, a circuit pattern formation process is based on a photolithographic process and an imprinting process. However, the photolithographic process incurs a high manufacturing cost because it has many process steps, and increases a defect rate, resulting in very unreliable products. Further, upon the formation of a fine circuit pattern, a side-etching phenomenon, in which a copper foil to be protected under an etching resist is over-etched by an etching process, occurs. Hence, the photolithographic process imposes limits on the realization of a fine circuit pattern.

Conventional imprinting processes are largely classified into stamping, roll-to-roll, or molding.

A stamping process for use in the formation of a pattern at one time using a stamp is illustrated in FIG. 1. As in FIG. 1, an imprinting master 1 is positioned on a desired molding layer 2 to be spaced apart from the molding layer 2 by a predetermined distance, after which the imprinting master 1 is pressed into the molding layer 2 to form a desired pattern in the molding layer, which is disclosed in U.S. patent application Publication No. 2003-17424.

FIG. 2 illustrates a conventional roll-to-roll process, which is developed for mass production. As illustrated in FIG. 2, upper and lower rollers 3, 5 are rotated in opposite directions to each other to transfer a substrate 4 to a predetermined direction while tightly contacting the substrate 4, thus forming a pattern in the substrate 4. The upper roller 3 has a pattern, whereas the lower roller 5 has no pattern.

In this regard, Korean Patent Laid-open Publication No. 2004-32655 discloses a method of forming a pattern, using a substrate coated with a UV curing resin, a roller spaced apart from the upper surface of the substrate by a predetermined distance to be rotated correspondingly to the transfer direction of the substrate, a pattern plate attached to the outer surface of the roller in negative form to transcribe a pattern to the UV curing resin of the substrate, and a curing means for curing the UV curing resin having a pattern transcribed by the pattern plate.

Further, a conventional molding process is a technique for forming a pattern by loading a material into a mold having a pattern.

However, of the imprinting processes, the stamping process using a stamp comprising a body part and a pattern part integrated together suffers because a tool-foil must be manufactured depending on the size of the substrate or the type of circuit pattern, thus the process cost increases and process efficiency is decreased. Therefore, it is possible to apply the stamping process only to a small substrate.

In addition, when the tool-foil of the stamp is pressed into the substrate and then released from the substrate, it is difficult to release from the substrate.

Also, the roll-to-roll process may cause a problem with respect to the exact alignment of the substrate and the stamp to form a pattern.

### SUMMARY OF THE INVENTION

Accordingly, the present invention has been made keeping in mind the above problems occurring in the related art, and an object of the present invention is to provide an imprinting apparatus, system and method, capable of forming various patterns in a large substrate in a short time, thus increasing productivity and decreasing a manufacturing cost.

Another object of the present invention is to provide an imprinting apparatus, system and method, capable of uniformly forming a pattern and realizing easy release from a substrate.

In order to accomplish the above objects, the present invention provides an imprinting apparatus, including a semi-cylindrical body part having a curved lower surface and a flat upper surface, and a pattern part provided on the curved lower surface of the body part.

In addition, the present invention provides an imprinting system, including an imprinting apparatus having a pattern part that includes a pattern corresponding to a circuit pattern, a heat plate spaced apart from the pattern part of the imprinting apparatus by a predetermined distance, an entry detection sensor disposed at the substrate entering part of the heat plate to detect entry of the substrate onto the heat plate, a supply completion sensor disposed at the substrate discharge part of the heat plate to detect completion of supply of the substrate onto the heat plate, and an imprinting completion sensor spaced apart from the supply completion sensor by a predetermined distance to detect the imprinting completion of the substrate.

In addition, the present invention provides an imprinting method, that includes the steps of providing a semi-cured thermosetting substrate, aligning the substrate to be parallel to a transfer direction thereof, supplying the aligned substrate on a heat plate, aligning the substrate supplied on the heat plate, imprinting the substrate using an imprinting apparatus including a pattern part having a pattern corresponding to a circuit pattern, and discharging the imprinted substrate.

### BRIEF DESCRIPTION OF THE DRAWINGS

FIG. 1 illustrates an imprinting apparatus for use in a conventional stamp process;

FIG. 2 illustrates another imprinting apparatus for use in a conventional roll-to-roll process;

FIG. 3 illustrates an imprinting apparatus, according to an embodiment of the present invention;

FIG. 4 illustrates an imprinting apparatus, according to another embodiment of the present invention;

FIGS. 5A to 5C illustrate an imprinting process using the imprinting apparatus according to the embodiment of FIG. 3; and

FIGS. 6A to 6E illustrate an imprinting process using an imprinting system of the present invention.

### DETAILED DESCRIPTION OF THE INVENTION

Hereinafter, a detailed description will be given of the present invention, with reference to the appended drawings.

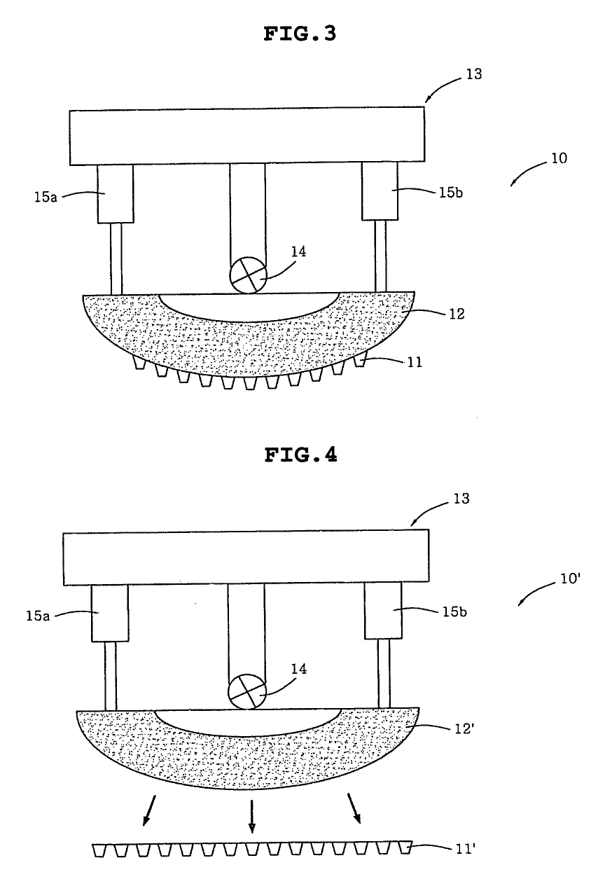

FIG. 3 illustrates an imprinting apparatus 10, according to an embodiment of the present invention.

As illustrated in FIG. 3, the imprinting apparatus 10 includes a semi-cylindrical body part 12 having a curved lower surface and a flat upper surface, and a pattern part 11 provided on the curved lower surface of the body part 12.

In addition, the imprinting apparatus 10 further includes a pressure part 13 for sequentially pressurizing the upper surface of the body part 12.

The pressure part 13 includes a first pressure rod 15a and a second pressure rod 15b for sequentially applying pressure to both sides of the body part 12 relative to a central shaft 14 of the body part 12. The pressurization by the first and second pressure rods 15a and 15b may be conducted using a known pressure device, such as a pneumatic pump or a hydraulic pump.

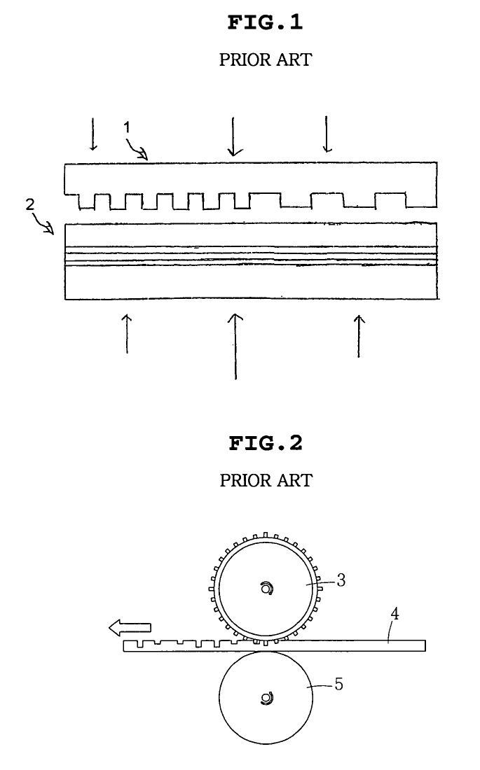

That is, the imprinting apparatus 10 according to the present embodiment is advantageous because pressure is sequentially applied to the whole surface of the substrate to be imprinted, compared to a conventional stamping process for pressurizing the whole surface of a substrate at one time as shown in FIG. 1.

FIG. 4 illustrates an imprinting apparatus 10′, according to another embodiment of the present invention.

Like the imprinting apparatus 10 shown in FIG. 3, the imprinting apparatus 10′ according to the present embodiment includes a semi-cylindrical body part 12′ having a curved lower surface and a flat upper surface, and a pattern part 11′ provided on the curved lower surface of the body part 12′, and further includes a pressure part 13 for sequentially pressurizing the upper surface of the body part 12′. In the imprinting apparatus according to the present embodiment, the pattern part 11′ is removably attached to the body part 12′, unlike the previous embodiment shown in FIG. 3.

In this case, a process of removably attaching the pattern part 11′ to the body part 12′ preferably includes forming a predetermined air passageway necessary for vacuum suction in the body part 12′ corresponding to the pattern part 11′ so as to removably attach the pattern part 11′ to the body part 12′ using a vacuum suction pump.

The imprinting apparatus 10′ according to the present embodiment is advantageous because only the pattern part 11′ varying with a circuit pattern is manufactured and the body part 12′ can be repeatedly used, compared to a conventional stamping process for undesirably manufacturing the whole body part including a pattern part, depending on a circuit pattern, as shown in FIG. 1. Hence, the imprinting apparatus 10′ can be applied even to a large substrate having a size of 405 mm×510 mm, thus easily forming a desired pattern.

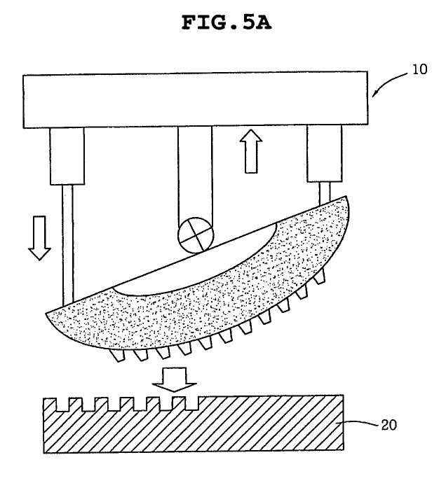

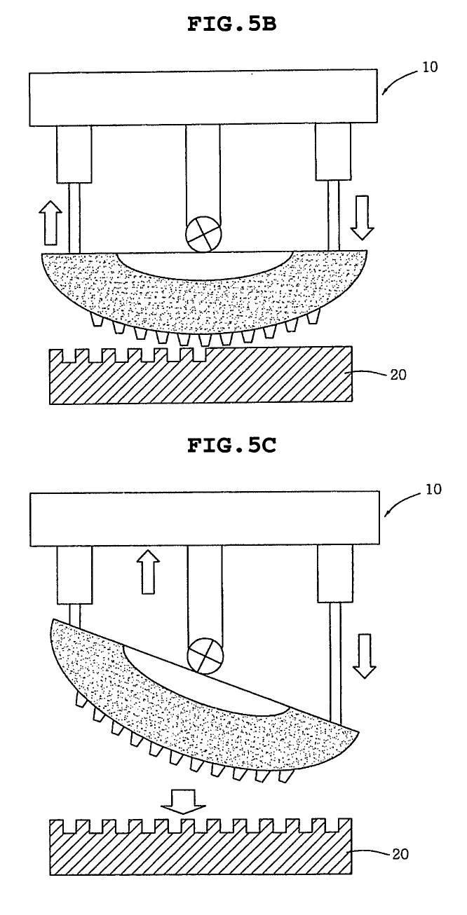

FIGS. 5A to 5C illustrate an imprinting process using the imprinting apparatus 10 according to the embodiment of FIG. 3.

FIG. 5A illustrates the state of a first pressure rod 15a to which pressure is applied. That is, the pressure is applied to the first pressure rod 15a relative to the central shaft 14, whereby a pattern begins to be formed in a substrate 20 by the pattern part 11 of the imprinting apparatus 10.

FIG. 5B illustrates the equilibrium state, in which the first pressure rod 15a and a second pressure rod 15b experience the same pressure, because pressure is applied to the second pressure rod 15b.

Finally, FIG. 5C illustrates the completion of the imprinting process, in which a pressure applied to the second pressure rod 15b is increased and a pressure applied to the first pressure rod 15a is reduced.

In this way, the imprinting apparatus 10, according to the embodiment of FIG. 3, functions to sequentially apply the pressure to the first pressure rod 15a and then to the second pressure rod 15b to uniformly form a pattern in the substrate 20, and is easily removed from the substrate 20.

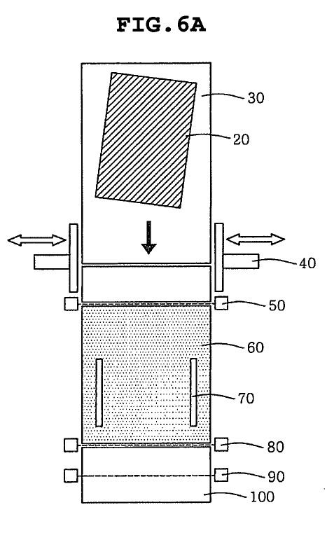

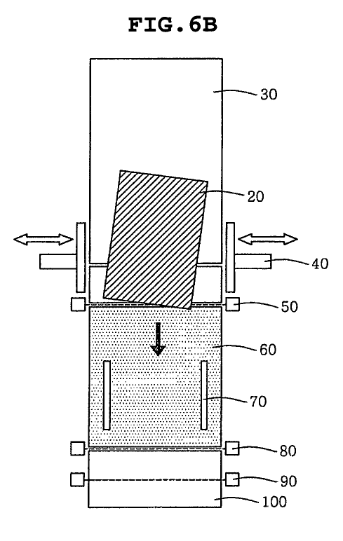

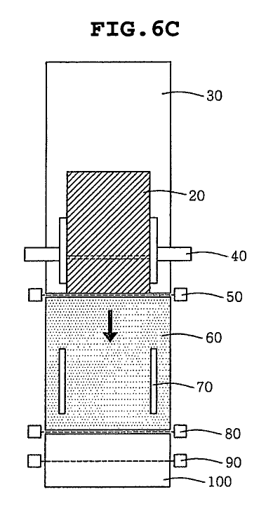

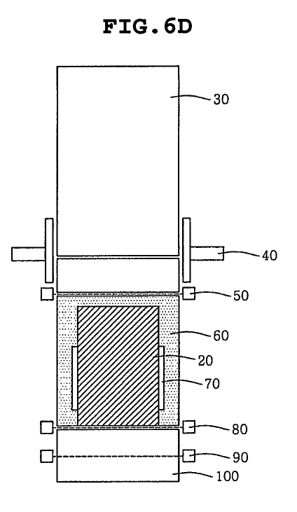

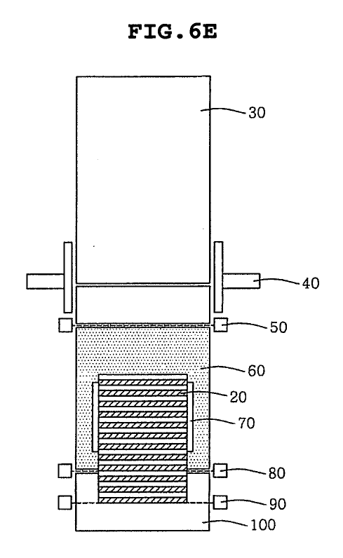

Turning now to FIGS. 6A to 6E, an imprinting process using an imprinting system of the present invention is illustrated.

As illustrated in FIG. 6A, a substrate 20 is placed on a transfer belt 30.

The substrate 20, which is formed of an epoxy mixture, is in a state of being semi-cured by the transfer belt 30, the temperature of which is controllable in the range from 50 to 250° C.

As shown in FIG. 6B, the substrate 20 begins to enter the area of a heat plate 60 by the transfer belt 30.

That is, the entry of the substrate 20 onto the heat plate 60 by the transfer belt 30 is detected by an entry detection sensor 50 provided at a position adjacent to the transfer belt 30 where the substrate moves onto the heat plate 60.

The entry detection sensor 50 is exemplified by known sensors able to detect the motion of an object, such as an infrared sensor, etc.

When the substrate 20 moves onto the heat plate 60, it is aligned by an alignment unit 40 positioned parallel to the side surface of the transfer belt 30, as shown in FIG. 6C.

The alignment unit 40 functions to exactly position the misaligned substrate 20, which moves in a state of being semi-cured by the transfer belt 30, while moving it from both sides, in order to easily and correctly form a pattern in the substrate in a subsequent imprinting process.

As shown in FIG. 6D, when the substrate 20 is completely supplied on the heat plate 60, it is further aligned by an assistant alignment unit 70 and is held on the heat plate 60 at the same time.

That is, when the substrate 20 has been completely supplied onto the heat plate 60, as detected by a supply completion sensor 80 positioned at the substrate discharge part of the heat plate 60, the substrate 20 stops moving and is then aligned and held using the assistant alignment unit 70.

As such, the assistant alignment unit 70 is fixed to the heat plate 60, unlike the alignment unit 40.

The supply completion sensor 80 is exemplified by known sensors able to detect the motion of an object, such as an infrared sensor, etc., like the entry detection sensor 50.

Finally, as shown in FIG. 6E, the held substrate 20 is imprinted (not shown), using the imprinting apparatus 10 or 10′ shown in FIG. 3 or 4, after which the patterned substrate 20 is discharged.

That is, after the substrate 20 is patterned by the imprinting apparatus 10 or 10′, the substrate 20 is slightly moved in the transfer direction by the rotation of the imprinting apparatus 10 or 10′. Then, the completion of the imprinting process is detected by an imprinting completion sensor 90 spaced apart from the supply completion sensor 80 by a predetermined distance in the transfer direction of the substrate, and the substrate 20 having a circuit pattern is discharged to a discharge belt 100, thereby obtaining the substrate having the pattern through an imprinting process.

As such, the imprinting completion sensor 90 is exemplified by known sensors able to detect the motion of an object, such as an infrared sensor, etc., like the entry detection sensor 50 or supply completion sensor 80.

As described hereinbefore, the present invention provides an imprinting apparatus, system and method. According to the imprinting apparatus, system and method of the present invention, a pattern part of the imprinting apparatus is removably attached to a body part thereof to easily form various circuit patterns, thereby overcoming the conventional problem regarding the fabrication of all of a stamp including a body part and a pattern part integrated together depending on the size of a substrate or the type of circuit pattern.

In addition, according to the imprinting apparatus, system and method of the present invention, the imprinting apparatus is formed in a semi-cylindrical shape to sequentially apply pressure, thereby overcoming the conventional problem caused when releasing the stamp from the substrate.

In addition, according to the imprinting apparatus, system and method of the present invention, an alignment unit and an assistant alignment unit are provided to align and hold the substrate, thus easily forming a pattern and decreasing a defect rate.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An imprinting apparatus, comprising:
a semi-cylindrical body part having a curved lower surface; and
a pattern part provided on the curved lower surface of the body part.

2. The imprinting apparatus as set forth in claim 1, further comprising a pressure part to sequentially apply pressure to an upper surface of the body part.

3. The imprinting apparatus as set forth in claim 1, wherein the pattern part is removably attached to the body part.

4. An imprinting system, comprising:
an imprinting apparatus including a pattern part having a pattern corresponding to a circuit pattern;
a heat plate spaced apart from the pattern part of the imprinting apparatus by a predetermined distance;
an entry detection sensor disposed at a substrate entering part of the heat plate to detect entry of a substrate onto the heat plate;
a supply completion sensor disposed at a substrate discharge part of the heat plate to detect completion of supply of the substrate onto the heat plate; and
an imprinting completion sensor spaced apart from the supply completion sensor by a predetermined distance to detect imprinting completion of the substrate.

5. The imprinting system as set forth in claim 4, further comprising an alignment unit provided at the substrate entering part of the heat plate to align both sides of the substrate.

6. The imprinting system as set forth in claim 4, further comprising an assistant alignment unit for aligning and holding the substrate on the heat plate.

7. The imprinting system as set forth in claim 4, wherein the imprinting apparatus further includes a semi-cylindrical body part having a curved lower surface and the pattern part provided on the curved lower surface of the body part.

8. The imprinting system as set forth in claim 7, wherein the pattern part is removably attached to the body part.

9. An imprinting method, comprising the steps of:
providing a semi-cured thermosetting substrate;
aligning the substrate to be parallel to a transfer direction thereof;
supplying the aligned substrate onto a heat plate;
aligning the substrate supplied on the heat plate;
imprinting the substrate using an imprinting apparatus including a pattern part having a pattern corresponding to a circuit pattern; and
discharging the imprinted substrate.

10. The method as set forth in claim 9, wherein the supplying step includes:
detecting entry of the substrate onto the heat plate by an entry detection sensor disposed at a substrate entering part of the heat plate; and
detecting completion of supply of the substrate onto the heat plate by a supply completion sensor disposed at a substrate discharge part of the heat plate.

11. The method as set forth in claim 9, wherein the imprinting step includes:
sequentially applying pressure to the imprinting apparatus to imprint the substrate; and
detecting imprinting completion of the substrate by an imprinting completion sensor spaced apart from the supply completion sensor by a predetermined distance.
